(19) United States
(12) Patent Application Publication
(10) Pub. No.: US 2024/0248630 A1
(43) Pub. Date: Jul. 25, 2024

(54) ONLINE FORMAT CONVERSION OF VIRTUAL DISK FROM REDO-LOG SNAPSHOT FORMAT TO SINGLE-CONTAINER SNAPSHOT FORMAT

(71) Applicant: VMware, Inc., Palo Alto, CA (US)

(72) Inventors: Zhen Liu, Shanghai (CN); Tao Xie, Shanghai (CN); Banghui Luo, Shanghai (CN); Enning Xiang, San Jose, CA (US); Carrie Yang, Beijing (CN); Kiran Patil, Fremont, CA (US)

(21) Appl. No.: 18/205,189

(22) Filed: Jun. 2, 2023

(30) Foreign Application Priority Data
Jan. 20, 2023 (WO) PCT/CN2023/000023

(51) Int. Cl. G06F 3/06

(52) U.S. Cl. CPC G06F 3/065; G06F 3/0619; G06F 3/067

(57) ABSTRACT

System and method for converting a storage object in a redo-log snapshot format to a single-container snapshot format in a distributed storage system uses a temporary snapshot object, which is created by taking a snapshot of the storage object, and an anchor object, which points to a root object of the storage object. For each object chain of the storage object, each selected object is processed for format conversion. For each selected object, difference data between the selected object and a parent object of the selected object is written to the anchor object, a child snapshot of the anchor object is created in the single-container snapshot format, and the anchor object is updated to point to the selected object. The data of the running point object of the storage object is then copied to the anchor object, and each processed object and the temporary snapshot object are removed.

### CROSS REFERENCE TO RELATED APPLICATIONS

This application claims priority from a PCT application No. PCT/CN2023/000023, filed on Jan. 20, 2023, which is incorporated herein by reference.

### BACKGROUND

A distributed storage system allows a cluster of host computers to aggregate local storage devices, which may be located in or attached to each host computer, to create a single and shared pool of storage. This pool of storage is accessible by all host computers in the cluster, including any virtualized computing instances (VCIs) running on the host computers, such as virtual machines, to store virtual disks and other storage objects. Because the shared local storage devices that make up the pool of storage may have different performance characteristics, such as capacity and input/output per second (IOPS) capabilities, usage of such shared local storage devices to store data may be distributed among the virtual machines based on the needs of each given virtual machine.

The shared pool of storage may support one of several possible snapshot formats, such as redo-log and B-tree snapshot formats, to preserve point-in-time (PIT) state and data of VCIs. Snapshots of VCIs are used for various applications, such as VCI replication, VCI rollback, and data protection for backup and recovery.

In certain situations, such as an upgrade of a shared storage, conversion of existing snapshots from a redo-log snapshot format to a B-tree snapshot format may be preferred. However, there are challenges to convert existing redo-log snapshots to B-tree snapshots in an efficient manner.

### SUMMARY

System and method for converting a storage object in a redo-log snapshot format to a single-container snapshot format in a distributed storage system uses a temporary snapshot object, which is created by taking a snapshot of the storage object, and an anchor object, which points to a root object of the storage object. For each object chain of the storage object, each selected object is processed for format conversion. For each selected object, difference data between the selected object and a parent object of the selected object is written to the anchor object, a child snapshot of the anchor object is created in the single-container snapshot format, and the anchor object is updated to point to the selected object. The data of the running point object of the storage object is then copied to the anchor object, and each processed object and the temporary snapshot object are removed.

A computer-implemented method for converting a storage object in a redo-log snapshot format to a single-container snapshot format in a distributed storage system in accordance with an embodiment of the invention comprises: taking a snapshot of the storage object to create a temporary snapshot object; creating an anchor object that originally points to a root object of the storage object; for each object chain of the storage object, processing each selected object in the object chain for format conversion including the temporary snapshot object, wherein processing each selected object includes: writing difference data between the selected object and a parent object of the selected object to the anchor object; after the difference data has been written to the anchor object, creating a child snapshot of the anchor object in the single-container snapshot format; and updating the anchor object to point to the selected object; after processing each selected object in each object chain of the storage object, copying data of a running point object of the storage object to the anchor object; and removing each selected object in each object chain of the storage object that has been processed for format conversion and the temporary snapshot object from the storage object. In some embodiments, the steps of this method are performed when program instructions contained in a computer-readable storage medium are executed by one or more processors.

A system in accordance with an embodiment of the invention comprises memory and at least one processor configured to: take a snapshot of the storage object to create a temporary snapshot object; create an anchor object that originally points to a root object of the storage object; for each object chain of the storage object, process each selected object in the object chain for format conversion including the temporary snapshot object, wherein the at least one processor is configured to write difference data between the selected object and a parent object of the selected object to the anchor object, create a child snapshot of the anchor object in the single-container snapshot format after the difference data has been written to the anchor object, and update the anchor object to point to the selected object to process each selected object; after each selected object in each object chain of the storage object has been processed, copy data of a running point object of the storage object to the anchor object; and remove each selected object in each object chain of the storage object that has been processed for format conversion and the temporary snapshot object from the storage object.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 is a block diagram of a distributed storage system with a format conversion engine in accordance with an embodiment of the invention.

FIG. 2 is a diagram of a virtual disk in a redo-log snapshot format in accordance with an embodiment of the invention.

FIG. 3 illustrates a read request to the virtual disk shown in FIG. 2 in accordance with an embodiment of the invention.

FIGS. 4A-4C illustrate a virtual disk in a B-tree snapshot format in accordance with an embodiment of the invention.

FIG. 5 illustrates a disk consolidation operation for a virtual disk in the redo-log snapshot format in accordance with an embodiment of the invention.

FIGS. 6A and 6B illustrate a snapshot reversion operation for a virtual disk in the redo-log snapshot format in accordance with an embodiment of the invention.

FIG. 7 is a flow diagram of a format conversion process of converting a virtual disk from the redo-log snapshot format to the B-tree snapshot format in the distributed storage system in accordance with an embodiment of the invention.

FIGS. 8A-8I illustrate a format conversion process of converting a virtual disk from the redo-log snapshot format to the B-tree snapshot format in accordance with an embodiment of the invention.

FIG. 9 is a component diagram of a virtual storage area network (VSAN) module included in each host computer in the distributed storage system shown in FIG. 1.

FIG. 10 is a flow diagram of a computer-implemented method for converting a storage object in a redo-log snapshot format to a B-tree snapshot format in a distributed storage system in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

Embodiments in accordance with the invention facilitate conversion of storage objects in a redo-log snapshot format to storage objects in a single-container snapshot format within a computing environment. As used herein, storage objects are any objects or entities used to store data, such as files, volumes or logical storage units. A storage object may include a chain of objects or object chain, which has a root object and one or more descendent objects, where a child object is created from a parent object. The root object is the state of the storage object when the first snapshot was taken. An example that will be used herein to describe the embodiments of the invention is a virtual disk that is used as a non-volatile memory of a virtual machine.

The redo-log snapshot format of a storage object is a storage object format that creates a child delta object of a parent object when a snapshot of the storage object is taken. The parent object is then considered a point-in-time (PIT) copy or snapshot of the storage object, and the child delta object is now the running point of the storage object to which new writes to the storage object are written. The objects of a storage object in the redo-log snapshot format are managed in different entities, e.g., different files, using external links. In contrast, the single-container snapshot format of a storage object is a storage object format that manages snapshots, which are maintained in a single-container entity, such as a file. Examples of the single-container snapshot format include copy-on-write snapshot formats, such as, a B+ tree snapshot format, and redirect-on-write snapshot formats.

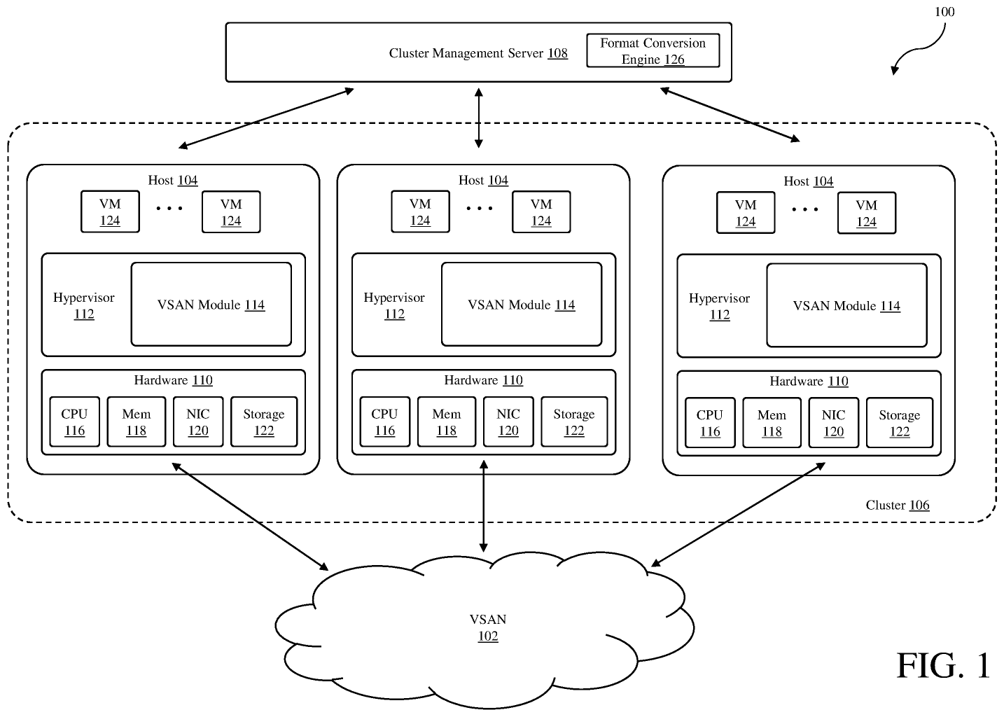

FIG. 1 illustrates a distributed storage system 100 with a storage system 102 in accordance with an embodiment of the invention. In the illustrated embodiment, the storage system 102 is implemented in the form of a software-based “virtual storage area network” (VSAN) that leverages local storage resources of host computers 104, which are part of a logically defined cluster 106 of host computers that is managed by a cluster management server 108 in the distributed storage system 100. The VSAN 102 allows local storage resources of the host computers 104 to be aggregated to form a shared pool of storage resources, which allows the host computers 104, including any virtual computing instances (VCIs) running on the host computers, to use the shared storage resources. In particular, the VSAN 102 may be used to store series of snapshots for files in an efficient manner, as described herein.

As used herein, the term “virtual computing instance” refers to any software processing entity that can run on a computer system, such as a software application, a software process, a virtual machine or a virtual container. A virtual machine is an emulation of a physical computer system in the form of a software computer that, like a physical computer, can run an operating system and applications. A virtual machine may be comprised of a set of specification and configuration files and is backed by the physical resources of the physical host computer. A virtual machine may have virtual devices that provide the same functionality as physical hardware and have additional benefits in terms of portability, manageability, and security. An example of a virtual machine is the virtual machine created using VMware vSphere® solution made commercially available from VMware, Inc of Palo Alto, California. A virtual container is a package that relies on virtual isolation to deploy and run applications that access a shared operating system (OS) kernel. An example of a virtual container is the virtual container created using a Docker engine made available by Docker, Inc. In this disclosure, the virtual computing instances will be described as being virtual machines, although embodiments of the invention described herein are not limited to virtual machines (VMs).

The cluster management server 108 of the distributed storage system 100 operates to manage and monitor the cluster 106 of host computers 104. The cluster management server 108 may be configured to allow an administrator to create the cluster 106, add host computers to the cluster and delete host computers from the cluster. The cluster management server 108 may also be configured to allow an administrator to change settings or parameters of the host computers in the cluster regarding the VSAN 102, which is formed using the local storage resources of the host computers in the cluster. The cluster management server 108 may further be configured to monitor the current configurations of the host computers and any VCIs running on the host computers, for example, VMs. The monitored configurations may include hardware configuration of each of the host computers and software configurations of each of the host computers. The monitored configurations may also include VCI hosting information, i.e., which VCIs (e.g., VMs) are hosted or running on which host computers. The monitored configurations may also include information regarding the VCIs running on the different host computers in the cluster.

The cluster management server 108 may also perform operations to manage the VCIs and the host computers 104 in the cluster 106. As an example, the cluster management server 108 may be configured to perform various resource management operations for the cluster, including VCI placement operations for either initial placement of VCIs and/or load balancing. The process for initial placement of VCIs, such as VMs, may involve selecting suitable host computers for placement of the virtual instances based on, for example, memory and central processing unit (CPU) requirements of the VCIs, the current memory and CPU loads on all the host computers in the cluster, and the memory and CPU capacity of all the host computers in the cluster.

In some embodiments, the cluster management server 108 may be a physical computer. In other embodiments, the cluster management server may be implemented as one or more software programs running on one or more physical computers, such as the host computers 104 in the cluster 106, or running on one or more VCIs, which may be hosted on any host computers. In an implementation, the cluster management server is a VMware vCenter™ server with at least some of the features available for such a server.

As illustrated in FIG. 1, each host computer 104 in the cluster 106 includes hardware 110, a hypervisor 112, and a VSAN module 114. The hardware 110 of each host computer includes hardware components commonly found in a physical computer system, such as one or more processors 116, one or more system memories 118, one or more network interfaces 120 and one or more local storage devices 122 (collectively referred to herein as “local storage”). Each processor 116 can be any type of a processor, such as a CPU commonly found in a server. In some embodiments, each processor may be a multi-core processor, and thus, includes multiple independent processing units or cores. Each system memory 118, which may be random access memory (RAM), is the volatile memory of the host computer 104. The network interface 120 is an interface that allows the host computer to communicate with a network, such as the Internet. As an example, the network interface may be a network adapter. Each local storage device 122 is a nonvolatile storage, which may be, for example, a solid-state drive (SSD) or a magnetic disk.

The hypervisor 112 of each host computer 104, which is a software interface layer, enables sharing of the hardware resources of the host computer by VMs 124, running on the host computer using virtualization technology. With the support of the hypervisor 112, the VMs provide isolated execution spaces for guest software. In other embodiments, the hypervisor may be replaced with an appropriate virtualization software to support a different type of VCIs.

The VSAN module 114 of each host computer 104 provides access to the local storage resources of that host computer (e.g., handle storage input/output (I/O) operations to data objects stored in the local storage resources as part of the VSAN 102) by other host computers 104 in the cluster 106 or any software entities, such as VMs 124, running on the host computers in the cluster. As an example, the VSAN module of each host computer allows any VM running on any of the host computers in the cluster to access data stored in the local storage resources of that host computer, which may include virtual disks (or portions thereof) of VMs running on any of the host computers and other related files of those VMs. In addition, the VSAN module generates and manages snapshots of files, such as virtual disk files of the VMs in an efficient manner.

In some embodiments, the VSAN module 114 may be configured or programmed to support virtual disks in redo-log snapshot format or support virtual disks in B-tree snapshot format, which allow the creation and use of snapshots of the virtual disks, as described in more detail below. A snapshot of a virtual disk represents the state of an associated virtual machine when the snapshot was taken, which can be used to revert the virtual machine back to that state at a later time.

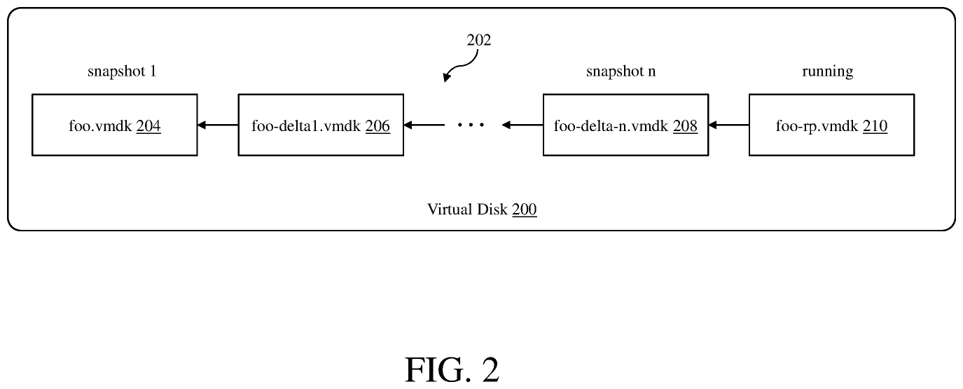

The redo-log snapshot format in accordance with an embodiment of the invention is now described with reference to FIG. 2, which shows a virtual disk 200 in the redo-log snapshot format. The virtual disk 200 includes a single disk chain 202 of virtual machine disks (VMDKs), which is formed by a foo.vmdk VMDK 204, a foo-delta1.vmdk VMDK 206 . . . a foo-delta-n.vmdk VMDK 208, and a foo-rp.vmdk VMDK 210.

However, virtual disks in the redo-log snapshot format may include multiple disk chains. In the virtual disk 200 shown in FIG. 2, the foo.vmdk VMDK 204 is the root VMDK of the virtual disk, i.e., the original VMDK when the first snapshot of the virtual disk was taken. Thus, the foo.vmdk VMDK 204 can be considered the first snapshot, which is indicated as “snapshot 1” in FIG. 2. The other VMDKs are delta disks from their parent disks. Each delta disk includes data changes from its parent disk. For example, the foo-delta1.vmdk VMDK 206 includes data changes from its parent disk, the foo.vmdk VMDK 204, the foo-delta2.vmdk VMDK (not shown) includes data changes from its parent disk, the foo-delta1.vmdk VMDK 204, and so on. The delta disk foo-rp.vmdk VMDK 210, is the running point VMDK of the virtual disk 200, which is used to write new data.

For a virtual disk in the redo-log snapshot format, when a snapshot of the virtual disk is taken, a single, independent object/file of a new delta disk is created. The parent disk of the new delta disk is then considered a point-in-time (PIT) copy. New writes by the virtual disk go to the new delta disk, which is the running point disk, while read requests will go to the parent and/or ancestor disks in the disk chain. All disks are organized together by external chains between different independent entities.

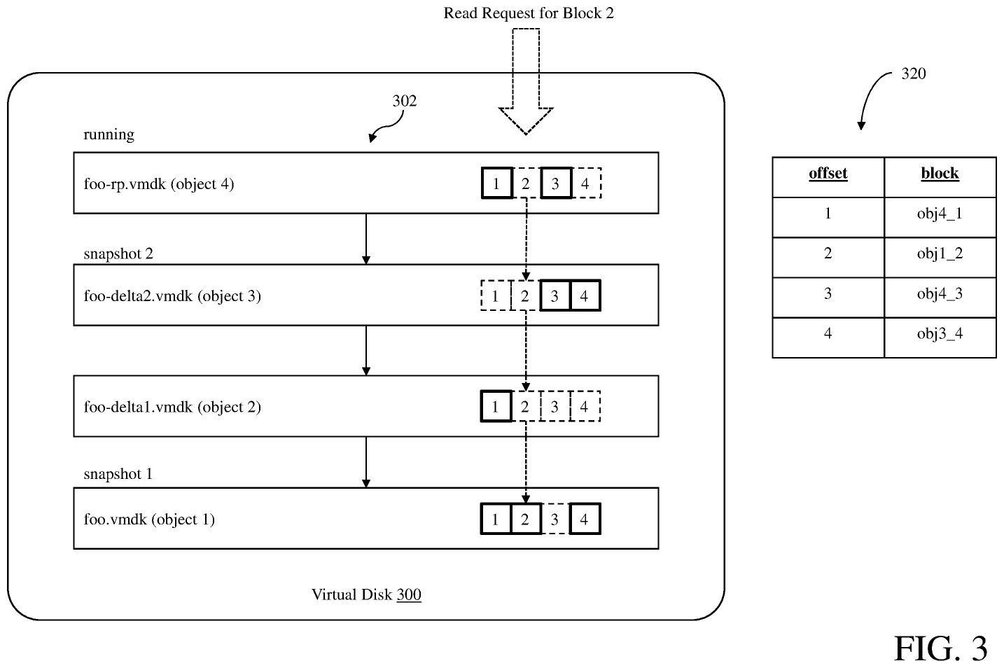

A read request to a virtual disk 300 in the redo-log snapshot format in accordance with an embodiment of the invention is illustrated in FIG. 3. As shown in FIG. 3, the virtual disk 300 includes a single disk chain 302 of a foo.vmdk VMDK (object 1), a foo-delta1.vmdk VMDK (object 2), a foo-delta2.vmdk VMDK (object 3) and a foo-rp.vmdk VMDK (object 4). The foo.vmdk VMDK and foo-delta2.vmdk VMDK are snapshots and the foo-rp.vmdk VMDK is the running point VMDK. The foo-delta1.vmdk VMDK is a non-snapshot delta disk. In this example, each VMDK includes data blocks 1, 2, 3 and 4, which correspond to offsets 1, 2, 3 and 4. However, as shown in FIG. 3, only some of the data blocks in the VMDKs include data, i.e., not empty, which are specified in a table 320 that lists the data blocks that are not empty. According to table 320, the data blocks 1 and 3 of the object 4 (i.e., the foo-rp.vmdk VMDK), the data block 2 of the object 1 (i.e., the foo.vmdk VMDK), and the data block 4 of the object 3 (i.e., the foo-delta2.vmdk VMDK) are not empty.

If there is a read request for data in a particular block in the virtual disk 300, then the disk chain of the virtual disk 300 is searched from the “top” VMDK, i.e., the running point VMDK (object 4), towards the “bottom” VMDK, i.e., the root VMDK (object 1) until the data is found in the corresponding block of one of the VMDKs. In the example illustrated in FIG. 3, a read request for data in block 2 is received. Since the data can be found in the block 2 of the foo.vmdk VMDK (object 1), the other VMDKs in the virtual disk 300 is searched before the desired data is found in the foo.vmdk VMDK (object 1).

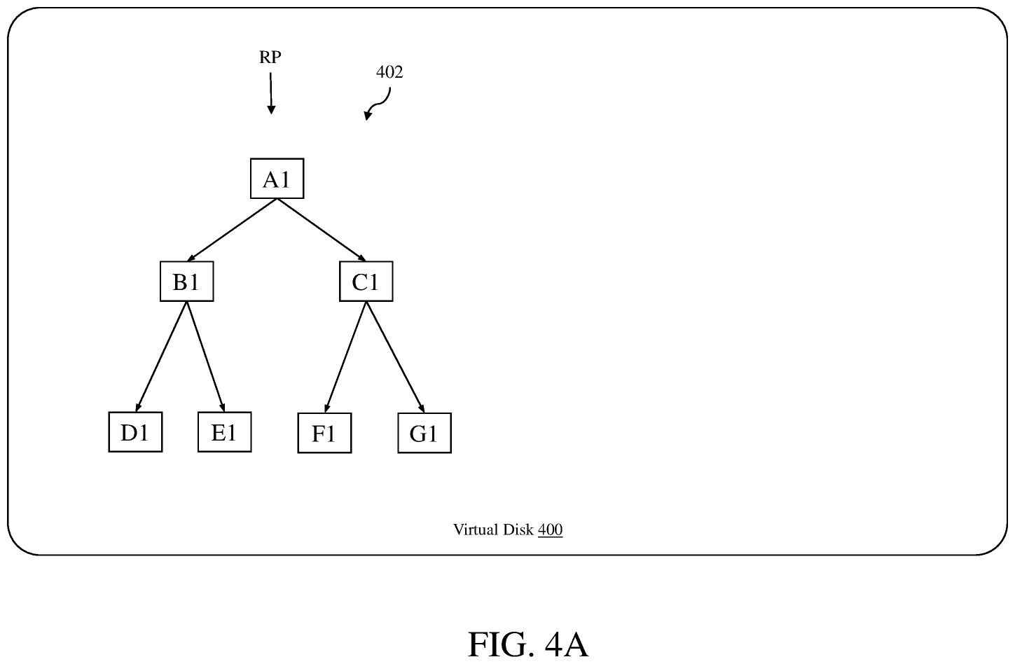

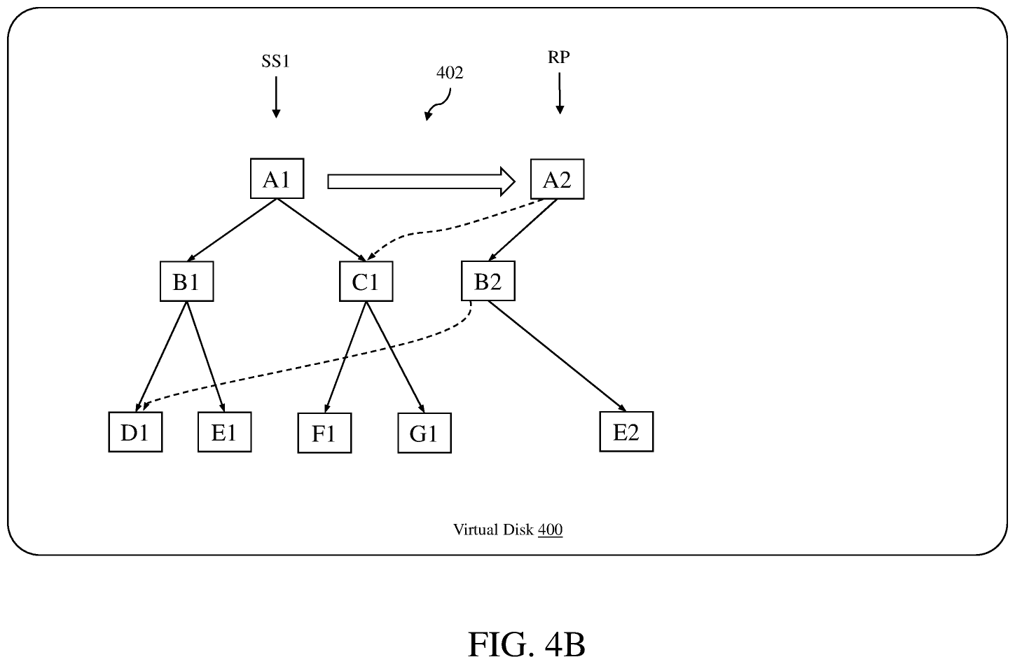

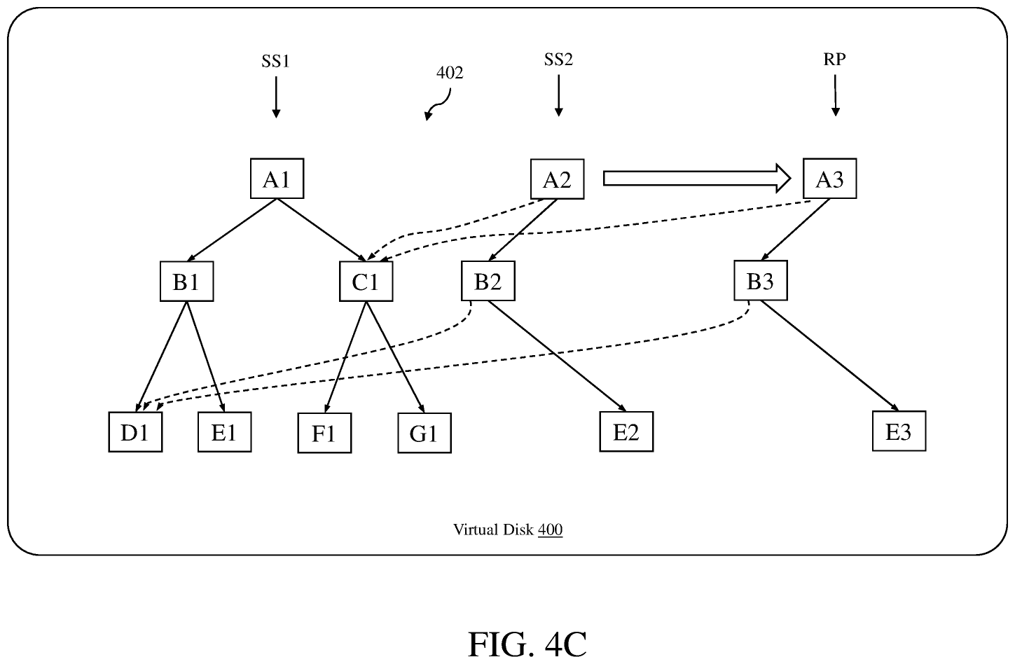

The B-tree snapshot format in accordance with an embodiment of the invention is now described with reference to FIGS. 4A-4C, which shows a virtual disk 400 in the B-tree snapshot format, or more specifically, in the B+ tree snapshot format. The B-tree snapshot format may be one implementation of a single-container snapshot format used in the distributed storage system 100. The main difference between a virtual disk in the redo-log snapshot format and a virtual in the single-container snapshot format is that the virtual disk in the single-container snapshot format is managed and maintained internally in a single-container entity, whereas the virtual in the redo-log snapshot format is managed by external links using multiple storage entities. The single-container snapshot format is sometimes known as the native snapshot format. The single-container snapshot format includes other copy-on-write snapshot formats and redirect-on-write snapshot formats.

FIG. 4A shows the virtual disk 400 before any snapshots were taken. In FIG. 4A, the virtual disk 400 includes nodes A1-G1, which define one tree of a B+ tree structure 402 (or one sub-tree if the entire B+ tree structure is viewed as being a single tree). The node A1 is the root node of the tree. The nodes B1 and C1 are index nodes of the tree. The nodes D1-G1 are leaf nodes of the tree, which are nodes on the bottom layer of the tree. As snapshots of the virtual disk 400 are created, more root, index and leaf nodes may be created, and thus, more trees may be created. Each root node contains references that point to index nodes. Each index node contains references that point to other nodes. Each leaf node records the mapping from logic block address (LBA) to the physical location or address in the storage system. Each node in the B+ tree structure 402 may include a node header and a number of references or entries. The node header may include information regarding that particular node, such as an identification (ID) of the node and an operation sequence number (SN). Each entry in the leaf nodes may include an LBA, physical extent location, checksum and other characteristics of the data for this entry. In FIG. 4A, the entire B+ tree structure 402 can be viewed as the current state or running point (RP) of the virtual disk 400. Thus, the nodes A1-G1 are exclusively owned by the running point and are modifiable.

FIG. 4B shows the virtual disk 400 after a first snapshot SS1 of the storage object was taken. Once the first snapshot SS1 is created or taken, all the nodes in the B+ tree structure 402 become immutable (i.e., cannot be modified). In FIG. 4B, the nodes A1-G1 have become immutable, preserving the virtual disk 400 to a point-in-time (PIT) when the first snapshot SS1 was taken. Thus, the tree with the nodes A1-G1 can be viewed as the first snapshot SS1.

When the first snapshot SS1 is taken, a new root node is set up or created. In addition, when new data on its range is written using copy on write (i.e., modification of the virtual disk 400), one or more index and leaf nodes are initialized. In FIG. 4B, the root node A2 has been created when the snapshot SS1 was taken, and new nodes B2 and E2 have been created when the virtual disk 400 was modified, which now define the running point of the virtual disk 400. Thus, the nodes A2, B2 and E2, as well as the nodes C1, D1, F1 and G1, which are common nodes for both the first snapshot SS1 and the current running point, represent the current state of the virtual disk 400.

FIG. 4C shows the virtual disk 400 after a second snapshot SS2 was taken. As noted above, once a snapshot is created or taken, all the nodes in the B+ tree structure 402 become immutable. Thus, in FIG. 4C, the nodes A2, B2 and E2 have become immutable, preserving the storage object to a point in time when the second snapshot SS2 was taken. Thus, the tree with the nodes A2, B2, E2, C1, D1, F1 and G1 can be viewed as the second snapshot.

When the second snapshot SS2 is taken, a new root node is set up or created, and one or more index and leaf nodes are initialized when the new data is written on the virtual disk 400. In FIG. 4C, the root node A3 has been created when the snapshot SS2 was taken, and new nodes B3 and E3 have been created when the virtual disk 400 was modified. Thus, nodes A3, B3 and E3 (which are only visible to the current running point), as well as the nodes C1, D1, F1 and G1 (which are visible to both the second snapshot and the current running point), represent the current state of the virtual disk.

Compared to the redo-log snapshot format approach, the organization and arrangement of data in the B-tree snapshot format approach can be more efficient and easier to manage. In addition, the performance of the virtual disk in the B-tree snapshot format will not be significantly degraded as more and more snapshots are created. In general, the number of snapshots supported by the virtual disk in the B-tree snapshot format can be sixty-four (64) or more. As for virtual disk in the redo-log snapshot format, it is not recommended to create too many snapshots due to performance degradation.

Thus, it may be desirable to convert virtual disks in the redo-log snapshot format to the B-tree snapshot format in certain situations. As an example, if the VSAN 102 of the distributed storage system 100 is being upgraded from a version that only supports the redo-log snapshot format to a version that supports the B-tree snapshot format, then existing virtual disks in the redo-log snapshot format can be converted to the B-tree snapshot format to take advantages of the benefits of the B-tree snapshot format. An another example, if virtual disks in the redo-log snapshot format is migrated from a distributed storage system that only supports the redo-log snapshot format to another distributed storage system that supports the B-tree snapshot format, then the virtual disks in the redo-log snapshot format can be converted to the B-tree snapshot format to again take advantages of the benefits of the B-tree snapshot format.

Thus, as illustrated in FIG. 1, the cluster management server 108 of the distributed storage system 100 includes a format conversion engine 126, which operates to convert virtual disks in the redo-log snapshot format stored in the VSAN 102 to virtual disks in the B-tree snapshot format. The format conversion operation executed by the format conversion engine 126, which may be initiated automatically or in response to a user command, is described detail below. But first, disk consolidation and snapshot reversion operations for a virtual disk in the redo-log snapshot format are described.

A disk consolidation operation involves searching for hierarchies or delta disks to combine without violating data dependency. After consolidation, redundant VMDKs are removed, which saves storage space for the virtual disk. For a virtual disk in the redo-log snapshot format, the data of the corresponding VMDK is written to its parent VMDK in the disk chain before it is deleted.

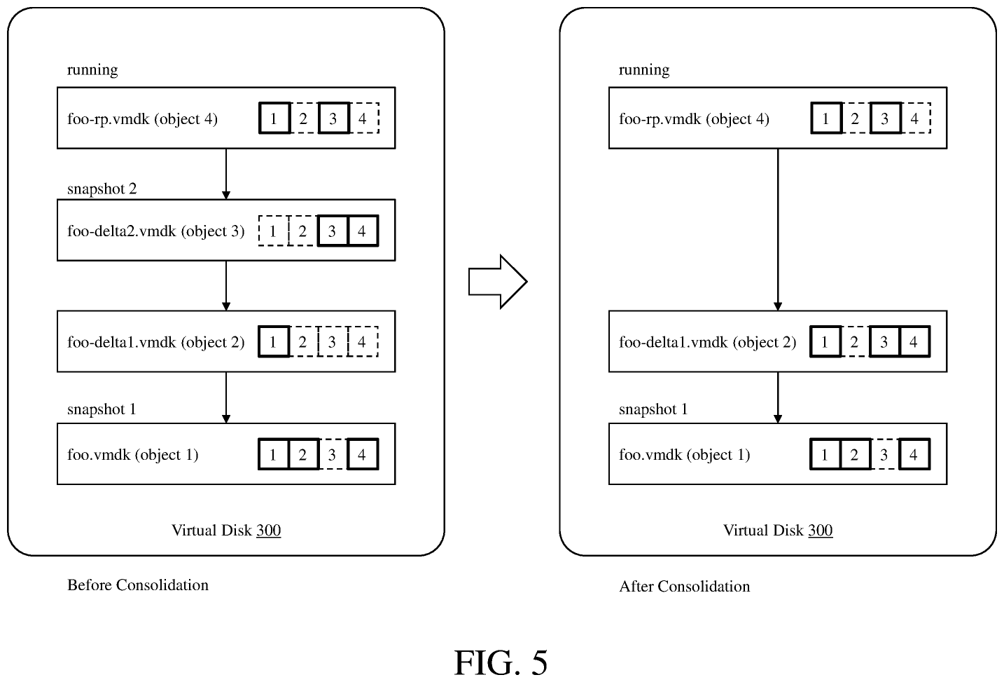

The disk consolidation operation for a virtual disk in the redo-log format is illustrated in FIG. 5 using the virtual disk 300 as an example. Before consolidation, the virtual disk 300 is in the same state as shown FIG. 3. In this example, the foo-delta2.vmdk VMDK (object 3) is consolidated with its parent foo-delta1.vmdk VMDK (object 2). That is, the data in the foo-delta2.vmdk VMDK (object 3), which is different than the data in its parent foo-delta1.vmdk VMDK (object 2) is merged into the parent foo-delta1.vmdk VMDK (object 2). The foo-delta2.vmdk VMDK (object 3) is then deleted. Thus, after the consolidation, the data in the blocks 3 and 4 of the foo-delta2.vmdk VMDK (object 3) are moved to the blocks 3 and 4 of the foo-delta1.vmdk VMDK (object 2). As a result of the consolidation, the performance of the redo-log format virtual disk 300 is improved as the number of VMDKs it depends on has decreased.

A snapshot reversion operation restores a virtual disk to the state when a specified snapshot was created. For a redo-log format virtual disk, the chain of delta disks in the virtual disk can simply be discarded and the virtual disk can be returned to a particular delta or base disk by creating a new delta disk to point to it. For a B-tree format virtual disk, the snapshot revision operation can be considered as an undo operation since it involves undoing the changes in the running point to clear data unique to the running point, de-referencing data blocks shared with the old parent snapshot and finally creating a new sharing with the parent snapshot to which the running point will point.

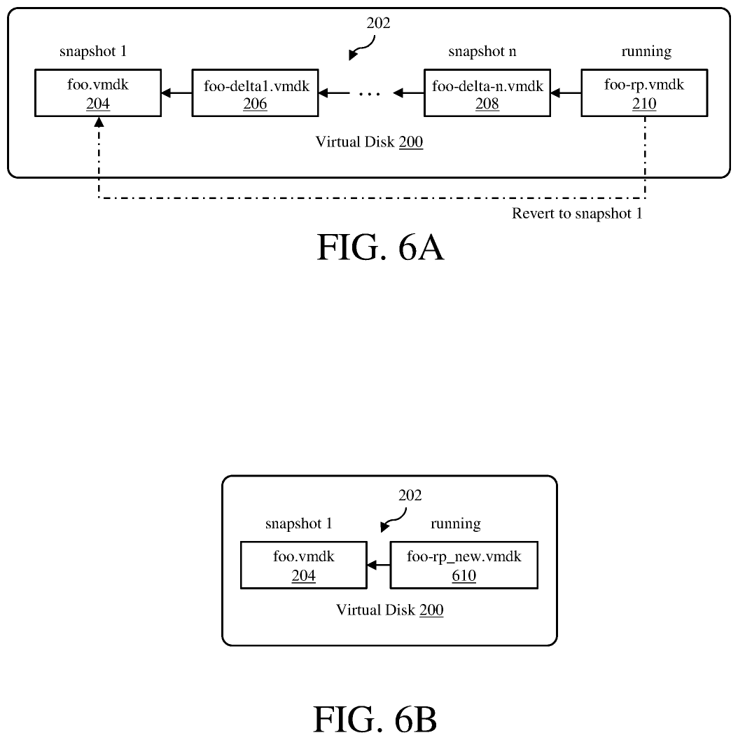

The snapshot reversion operation for a virtual disk in the redo-log format is illustrated in FIGS. 6A and 6B. The virtual disk 200 shown in FIG. 6A is the same virtual disk shown in FIG. 3. Thus, the virtual disk 200 includes the single disk chain 202 of the foo.vmdk VMDK 204, the foo-delta1.vmdk VMDK 206 . . . the foo-delta-n.vmdk VMDK 208, and the foo-rp.vmdk VMDK 210. The foo.vmdk VMDK 204 is the first snapshot disk “snapshot 1”. Thus, to revert to snapshot 1, the old running point (i.e., the foo.rp.vmdk VMDK 210) is deleted and a new delta disk, a foo-rp_new.vmdk VMDK 610 is created, which points to the foo.vmdk VMDK 204, as illustrated in FIG. 6B. It is noted here that the foo-delta1.vmdk VMDK 206 . . . the foo-delta-n.vmdk VMDK 208 and the foo-rp.vmdk VMDK 210 are not discarded because they are referenced by other snapshots.

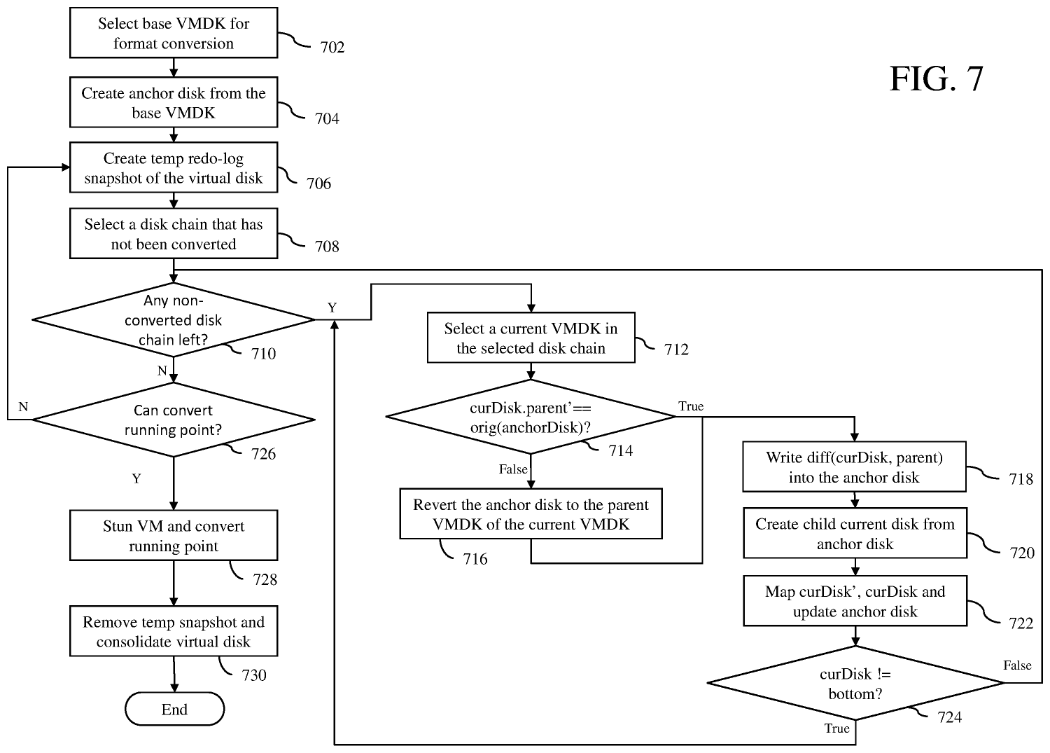

A format conversion process of converting a virtual disk from the redo-log snapshot format to the B-tree snapshot format, which is executed by the format conversion engine 126 in the distributed storage system 100, in accordance with an embodiment of the invention is now described with reference to a flow diagram of FIG. 7. The disk format conversion process begins at step 702, where a base VMDK (i.e., the root VMDK of the virtual disk) for format conversion is selected. Next, at step 704, an anchor disk is created from the base VMDK. An anchor disk, or generally an anchor object, is originally a copy of the root disk, which may be updated as needed.

Next, at step 706, a temporary redo-log snapshot of the virtual disk is created. Next, at step 708, an attempt is made to select a disk chain of the virtual disk that has not yet been converted. Next, at step 710, a determination is made whether there are any non-converted disk chains left in the virtual disk. If yes, then the process proceeds to step 712. If no, then the process proceeds to step 726.

At step 712, a current VMDK in the selected disk chain is selected to be processed. In an embodiment, the topmost VMDK in the selected disk chain that has not been previously processed is selected. Next, at step 714, a determination is made whether curDisk.parent′==orig(anchorDisk), where curDisk.parent is the parent VMDK of the current VMDK and the orig(anchorDisk) is the original anchor disk.

If curDisk.parent′==orig(anchorDisk) is true, then the process proceeds to step 716, where the anchor disk is reverted the parent VMDK of the current VMDK. The process then proceeds to step 718. However, if curDisk.parent′==orig(anchorDisk) is false, then the process proceeds directly to step 718, where diff(curDisk, parent) is written into the anchor disk. Diff(curDisk, parent) is the difference between the current VMDK and the parent VMDK of the current VMDK.

Next, at step 720, a child current disk (curDisk′) is created from the anchor disk, where the child current disk is the child VMDK of the current VMDK. Next, at step 722, the child current disk (curDisk′) is mapped to the current disk (curDisk), and the anchor disk is updated.

Next, at step 724, a determination is made whether curDisk !=bottom, i.e., whether the current VMDK is not equal to the bottom of the current disk chain. If curDisk !=bottom is true, then the process proceeds to step 712, where the next VMDK in the current disk chain is selected to be processed. If curDisk !=bottom is false, then the process proceeds back to step 710, where an attempt is made to select another non-converted disk chain in the VMDK for format conversion.

If there are no non-converted disk chains left in the virtual disk and the running point of the virtual disk can be converted (step 710), then a determination is made whether the running point of the virtual disk can be converted, at step 726. If the running point cannot be converted, then the process proceeds back to step 706, where another temporary redo-log snapshot of the virtual disk is created. However, if the running point can be converted, then the process proceeds to step 728, where the virtual machine associated with the virtual disk is stunned and the running point of the virtual disk is converted to the B-tree format.

Next, at step 730, the temporary snapshot is removed and the virtual disk is consolidated. The process then comes to an end.

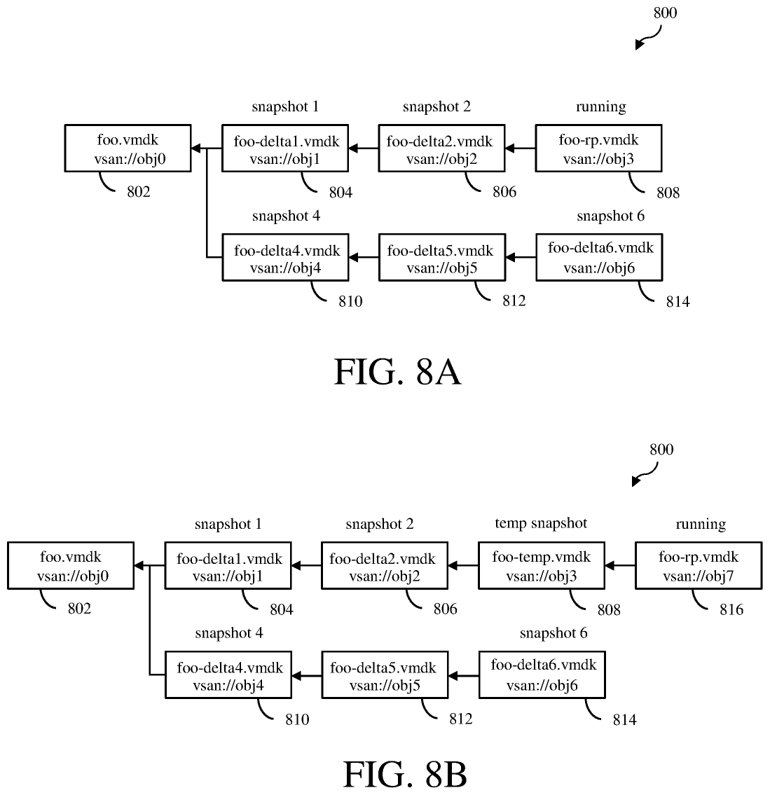

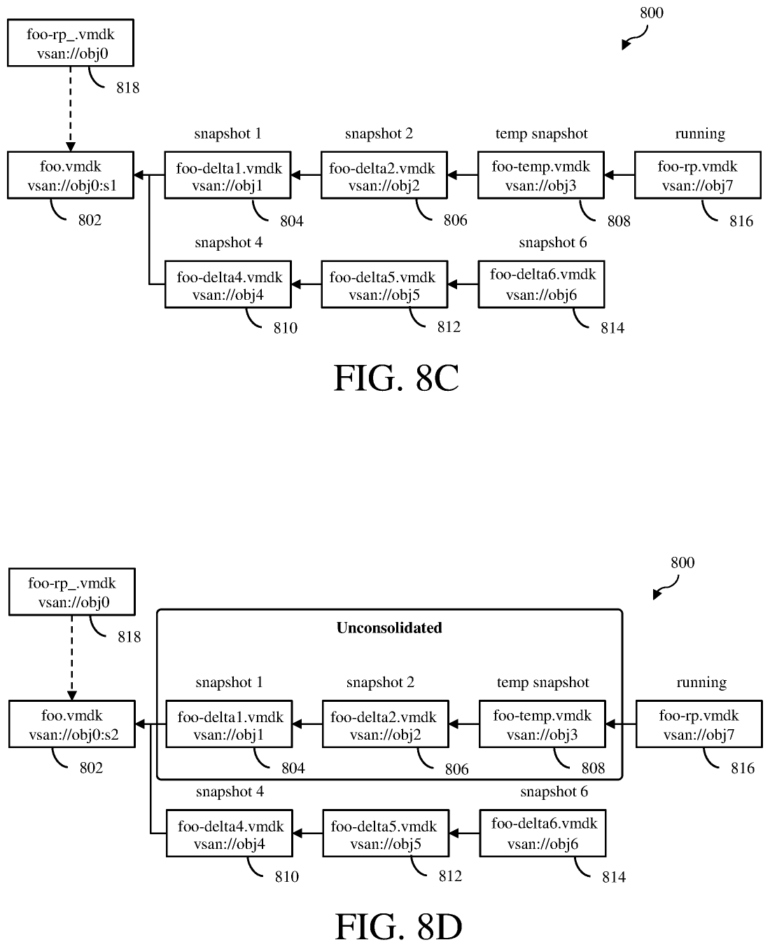

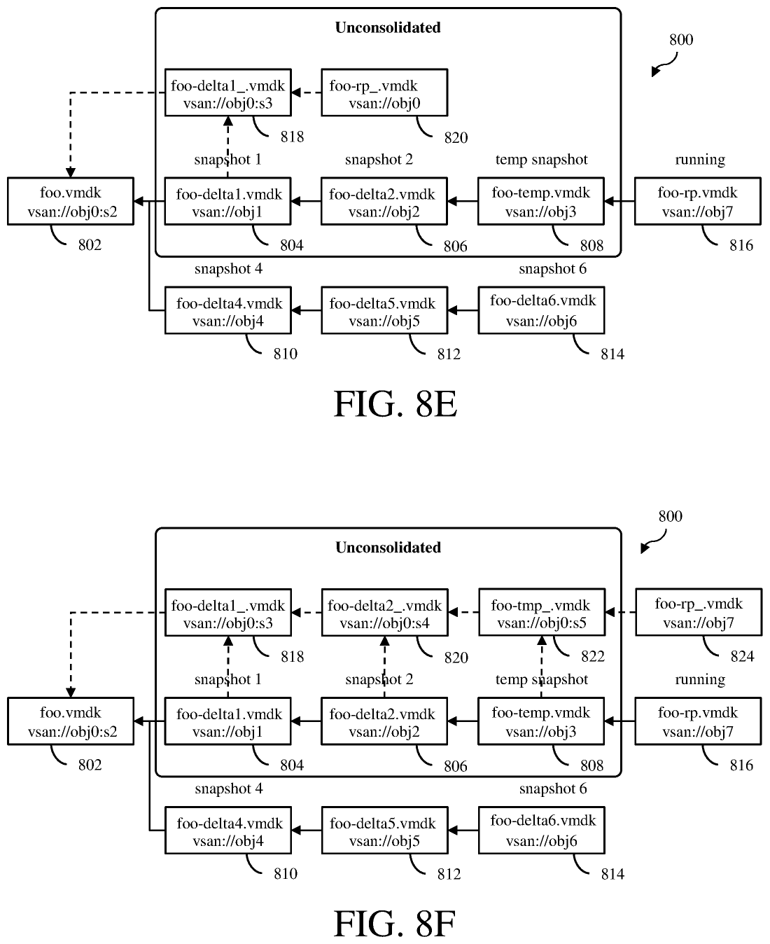

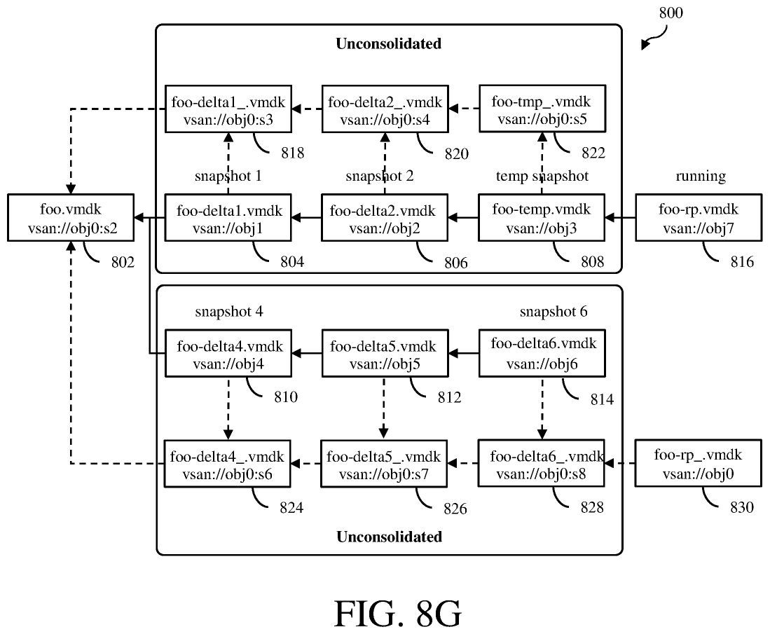

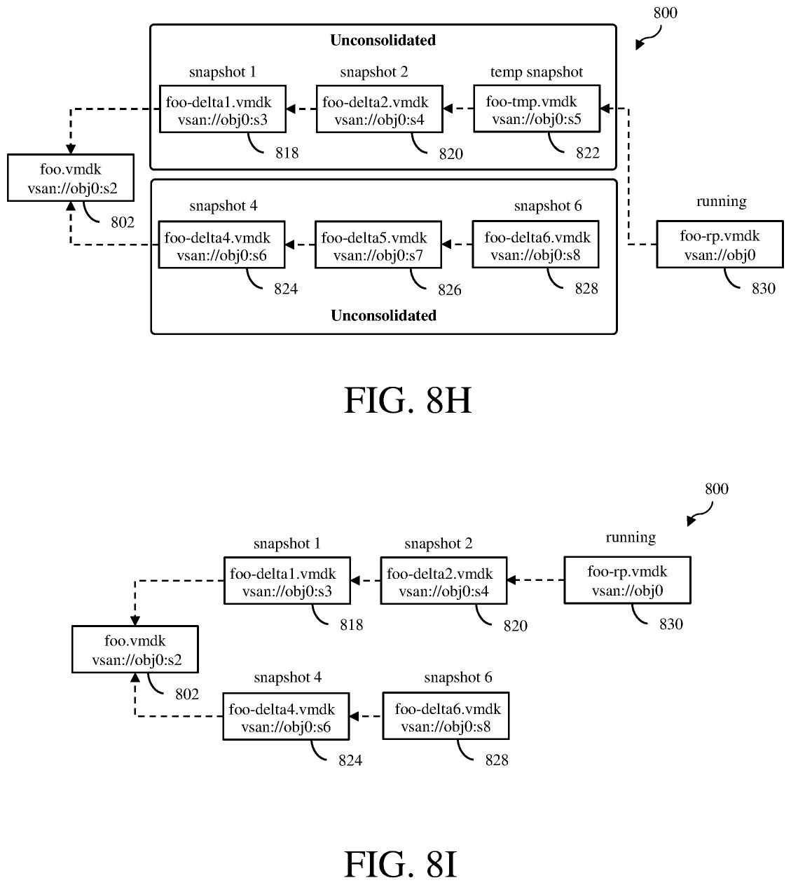

The format conversion in accordance with an embodiment of the invention is further described using an example of a virtual disk 800 with multiple disk chains being converted, which is illustrated in FIGS. 8A-8I. As shown in FIG. 8A, the virtual disk 800 includes a first disk chain of VMDKs 802-808 and a second disk chain of VMDKs 802 and 810-814. The foo.vmdk VMDK 802 is the root VMDK of the virtual disk 800 and the foo-rp.vmdk VMDK is the running point of the virtual disk 800. The VMDKs 804, 806, 810 and 814 are snapshots 1, 2, 4 and 6, respectively. The VMDK 812 is a non-snapshot redo-log disk. The non-snapshot VMDK 812 may be the result of removal of snapshots 0 and 5 without consolidating the whole virtual disk. The VMDK 802 (which belonged to snapshot 0 before that snapshot was deleted) is also a non-snapshot redo-log disk.

The format conversion of the virtual disk 800 is accomplished by locking the virtual machine corresponding to the virtual disk, i.e., the virtual machine using the virtual disk as a storage device, then taking a temporary snapshot of the virtual disk, and then unlocking the virtual machine. The temporary snapshot is then recorded and then deleted after all the VMDKs of the virtual disk have been converted. The creation of the temporary snapshot is illustrated in FIG. 8A, where the previous running point VMDK 808 is made into the temporary snapshot, which results in a new running point foo-rp.vmdk VMDK 816.

Note: the following steps lock the corresponding VM and then release the lock when the operation is complete.

As illustrated in FIG. 8C, the foo.vmdk VMDK 802 is first chosen as the final base VMDK to complete the virtual disk format conversion. The virtual machine corresponding to the virtual disk is then stunned and a child foo-rp_.vmdk VMDK 818 in the B-tree snapshot format is created from the base foo.vmdk VMDK 802. The child foo.vmdk VMDK is fixed as a read-only snapshot disk since data on a normal snapshot cannot be modified. The virtual machine is then unstunned and the foo-rp_.vmdk VMDK 818 is recorded as the original anchor disk, which is pointing to the original base VMDK 802. Thus, object 0 becomes the final container object of the target virtual disk.

Next, all the disk chains of the virtual disk 800 are traversed to detect disk chains to be converted. These disk chains exclude the base foo.vmdk VMDK 802 (root VMDK) and the current running point VMDK 816 for conversion. In the example shown in FIG. 8B, the following disk chains of the virtual disk 800 are detected:
Disk Chain 1: foo-delta1.vmdk←foo-delta2.vmdk←foo-tmp.vmdk
Disk Chain 2: foo-delta4.vmdk←foo-delta5.vmdk←foo-delta6.vmdk

Next, as illustrated in FIG. 8D, the disk chain 1 is selected for conversion and all the VMDKs in the disk chain 1 are marked as unconsolidated in a description database of the virtual disk 800, which may be maintained by the format conversion engine 126. Thus, the foo-delta1.vmdk VMDK 804, the foo-delta2.vmdk VMDK 806 and the foo-tmp.vmdk VMDK 808 are marked as unconsolidated, using, for example, one or more flags.

Next, the VMDKs in the disk chain 1 are individually converted from top to bottom. For each VMDK in the disk chain the following steps are performed. First, a determination is made whether the original VMDK (the root VMDK) to which the anchor disk points is the same VMDK as the parent disk of the current VMDK. If true, then no action is taken. If not true, then the anchor disk is reverted to the parent disk of the current VMDK. Next, the data that is different between the current VMDK and the parent disk is written to the anchor disk and a child disk from the anchor disk in the B-tree format or the single-container snapshot format is created so that the data on the newly created single-container snapshot is the same as the current VMDK. The information of the B-tree format child disk is then stored in the current VMDK to delay replacing the backing information. Finally, the anchor disk is updated to point to the current VMDK.

The conversion of the foo-delta1.vmdk VMDK 804 (the top VMDK in the disk chain 1) is now described with reference to FIG. 8E. First, a determination is made whether the original VMDK (the foo.vmdk VMDK 802 in the example) to which the anchor disk (the foo-rp_.vmdk VMDK 818 shown in FIG. 8D) points is the same VMDK as the parent disk (the foo.vmdk VMDK 802) of the current VMDK (the foo-delta1.vmdk VMDK 804). Since this is true for the foo-delta1.vmdk VMDK 804, no action is taken. Next, the data that is different between the current VMDK (the foo-delta1.vmdk VMDK 804) and the parent disk (the foo.vmdk VMDK 802) is written to the anchor disk (the foo-rp_.vmdk VMDK 818 shown in FIG. 8D). In addition, a child disk is created from the anchor disk (the foo-rp.vmdk VMDK 818 shown in FIG. 8D) in the B-tree snapshot format so that the newly created single-container snapshot disk and the current VMDK (the foo-delta1.vmdk VMDK 804) have the same data. As a result, the previous anchor disk (the foo-rp_.vmdk VMDK 818 shown in FIG. 8D) is now the parent disk (the foo-delta1_.vmdk VMDK 818) of the new anchor disk (a foo-rp_.vmdk VMDK 820). Thus, the foo-delta1_.vmdk VMDK 818, which is in the B-tree snapshot format, is the converted version of the foo-delta1.vmdk VMDK 804 in the redo-log snapshot format.

The information of the B-tree format child disk (the foo-delta1_.vmdk VMDK 818) is then stored in the current VMDK (the foo-delta1.vmdk VMDK 804) to delay replacing the backing information. Finally, the anchor disk is updated to point to the current VMDK.

This process is iterated through the disk chain 1 until the conversion of the foo-temp.vmdk VMDK 808 is completed, i.e., when a foo-tmp_.vmdk VMDK 822 has been created, as illustrated in FIG. 8F. That is, the foo-delta2.vmdk VMDK 806 and then the foo-temp.vmdk VMDK 808 are processed or converted. FIG. 8F illustrates the virtual disk 800 after all the VMDKs in the disk chain 1 have been converted. As a result, a new anchor disk, i.e., a foo-rp_.vmdk VMDK 824, is created.

Next, the disk chain 2 of the virtual disk 800 is converted in the same way as the disk chain 1 of the virtual disk 800. FIG. 8G illustrates the virtual disk 800 after the disk chain 2 has been converted. It is noted here that at the start of the disk chain 2 conversion the anchor disk points to the foo-tmp.vmdk VMDK 808, which does not match the parent disk of the foo-delta4.vmdk VMDK 810. Thus, the anchor disk is first reverted to the foo-vmdk VMDK 802. As a result of the conversion of the disk chain 2, the previous anchor disk (the foo-rp_.vmdk VMDK 824 shown in FIG. 8F) is now the foo-delta4_.vmdk VMDK 824 and new VMDKs 826-830 in the B-tree snapshot format are created. The foo-rp_.vmdk VMDK 830 is now the new anchor disk.

After completing the conversion of the existing disk chains of the virtual disk 800, the layout of the corresponding virtual disk is reobtained and compared. If one or more new snapshot are generated for the virtual disk, the conversion is continued in the disk chain with the running point VMDK until there are no more new snapshots. In addition, at the same time, the size of the running point VMDK is checked to see whether it exceeds a predefined threshold. If this condition is met, then a temporary snapshot is created and converted in the same manner.

When only the running point VMDK is left unconverted and the size of the running point VMDK is not too large, i.e., does not exceed the threshold, the virtual machine (VM) associated with the virtual disk 800 is locked and stunned to block additional snapshot requests. In an embodiment, all VM operations will be stopped as the virtual CPU of the VM will be stopped. Furthermore, because the virtual CPU of the VM is stopped, there will be no new guest inputs/outputs (IOs) written to the current running point VMDK. In addition, after reverting the anchor disk to the mapping parent foo-tmp_.vmdk VMDK 822 of the current running point foo-rp.vmdk VMDK 816, the data from the running point VMDK is copied to the current anchor disk. Finally, the disk path of the virtual disk is replaced with the anchor disk in the virtual machine configuration when the replication is complete.

During the callback of the unstun phase of the virtual machine, all VMDKs on the snapshot tree, which still includes redo-log format disk chains, are rearranged. The replacement operation is then executed, which involves removing the old delta VMDKs in the background asynchronously. The result of the replacement operation on the virtual disk 800 is illustrated in FIG. 8H. Next, the virtual disk 800 is reloaded and the running point VMDK is reopened.

Next, the unconsolidated flag set earlier may be unset and all temporarily created snapshots are removed. A disk consolidation operation is then performed. FIG. 8I illustrates the virtual disk after the disk consolidation operation has been completed. The format conversion process is now complete.

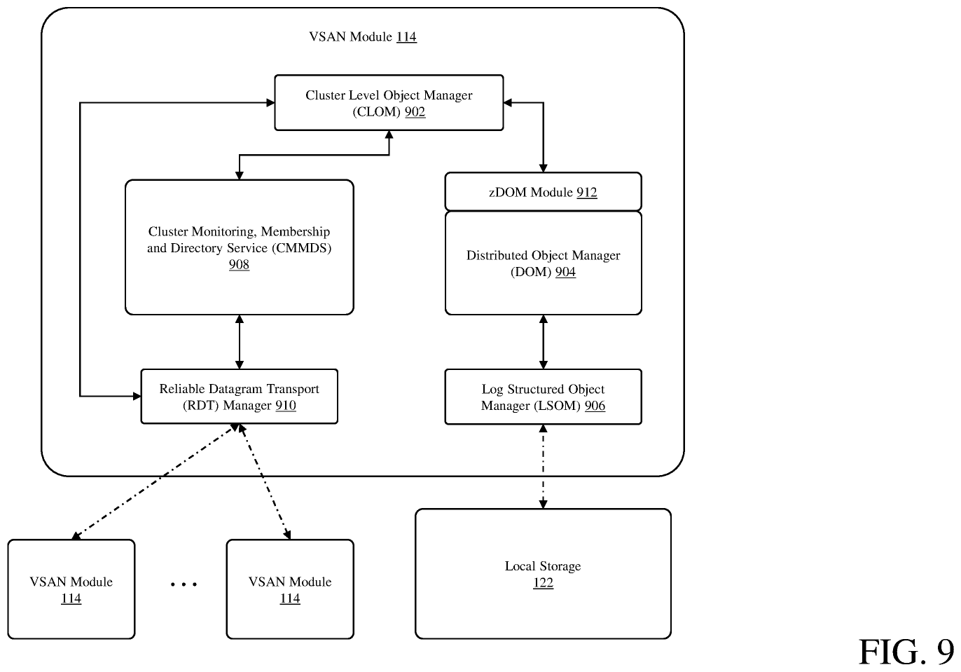

Turing now to FIG. 9, components of the VSAN module 114, which is included in each host computer 104 in the cluster 106, in accordance with an embodiment of the invention are shown. Some of these components may assist the format conversion engine 126 to execute the format conversion process described herein. As illustrated in FIG. 9, the VSAN module 114 includes a cluster level object manager (CLOM) 902, a distributed object manager (DOM) 904, a local log structured object management (LSOM) 906, a cluster monitoring, membership and directory service (CMMDS) 908, and a reliable datagram transport (RDT) manager 910. These components of the VSAN module may be implemented as software running on each of the host computers in the cluster.

The CLOM 902 operates to validate storage resource availability, and the DOM 904 operates to create components and apply configuration locally through the LSOM 906. The DOM 904 also operates to coordinate with counterparts for component creation on other host computers 104 in the cluster 106. All subsequent reads and writes to storage objects funnel through the DOM 904, which will take them to the appropriate components. The LSOM 906 operates to monitor the flow of storage I/O operations to the local storage 122, for example, to report whether a storage resource is congested. In an embodiment, the LSOM 906 is LSOM 2.0 used in VMware vSAN™ Express Storage Architecture (ESA) technology. The CMMDS 908 is responsible for monitoring the VSAN cluster's membership, checking heartbeats between the host computers in the cluster, and publishing updates to the cluster directory. Other software components use the cluster directory to learn of changes in cluster topology and object configuration. For example, the DOM uses the contents of the cluster directory to determine the host computers in the cluster storing the components of a storage object and the paths by which those host computers are reachable.

The RDT manager 910 is the communication mechanism for storage-related data or messages in a VSAN network, and thus, can communicate with the VSAN modules 114 in other host computers 104 in the cluster 106. As used herein, storage-related data or messages (simply referred to herein as “messages”) may be any pieces of information, which may be in the form of data streams, that are transmitted between the host computers 104 in the cluster 106 to support the operation of the VSAN 102. Thus, storage-related messages may include data being written into the VSAN 102 or data being read from the VSAN 102. In an embodiment, the RDT manager uses the Transmission Control Protocol (TCP) at the transport layer and it is responsible for creating and destroying on demand TCP connections (sockets) to the RDT managers of the VSAN modules in other host computers in the cluster. In other embodiments, the RDT manager may use remote direct memory access (RDMA) connections to communicate with the other RDT managers.

In an embodiment, the VSAN module 114 includes a zDOM module 912. The zDOM module is configured or programmed to execute operations related to single-container snapshots, e.g., creating and deleting snapshots. In a particular implementation, the zDOM module 912 performs full-stripe writes to Redundant Array of Independent Disks (RAID) 5/6 using persistent key-value stores, logs, transactions, caches, etc.

Although the format conversion process in accordance with embodiments of the invention has been described with respect to virtual disks, the format conversion process may be applied to any storage object, which can be any unit of stored data, that includes root, snapshot and running point components or objects. Thus, the format conversion process described herein can be used to convert any storage object from the redo-log snapshot format to a single-container snapshot format, such as a copy-on-write snapshot format, e.g., the B+ tree snapshot format, or a redirect-on-write snapshot format.

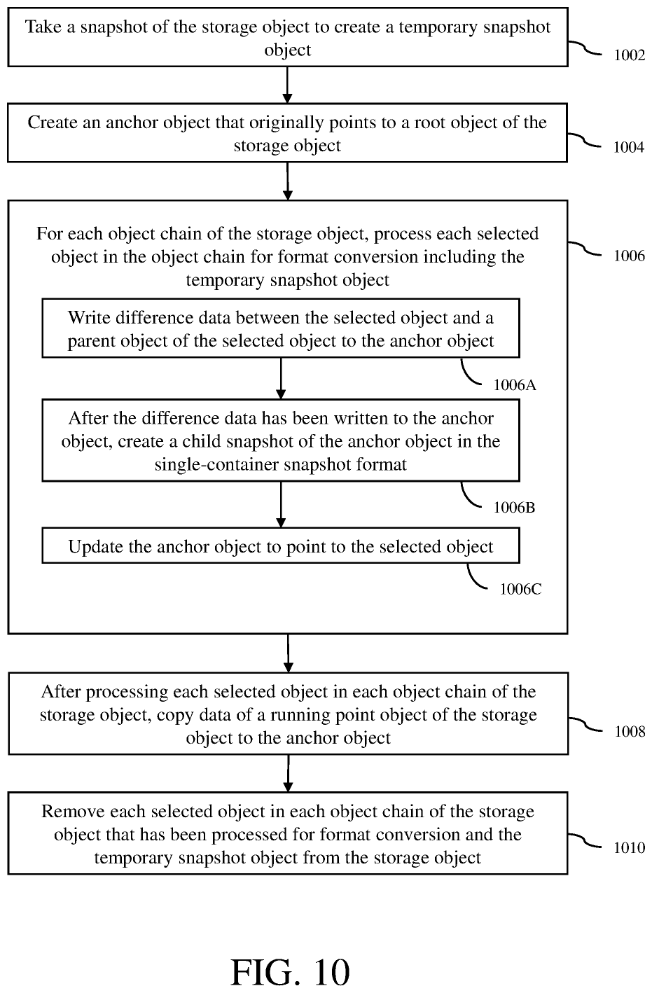

A computer-implemented method for converting a storage object in a redo-log snapshot format to a single-container snapshot format in a distributed storage system in accordance with an embodiment of the invention is described with reference to a flow diagram of FIG. 10. At block 1002, a snapshot of the storage object is taken to create a temporary snapshot object. At block 1004, an anchor object is created that originally points to a root object of the storage object. At block 1006, for each object chain of the storage object, each selected object in the object chain is processed for format conversion including the temporary snapshot object. The processing of each selected object includes subblocks 1006A-1006C. At subblock 1006A, difference data between the selected object and a parent object of the selected object is written to the anchor object. At subblock 1006B, after the difference data has been written to the anchor object, a child snapshot of the anchor object is created in the single-container snapshot format. At subblock 1006C, the anchor object is updated to point to the selected object.

At block 1008, after processing each selected object in each object chain of the storage object, data of a running point object of the storage object is copied to the anchor object. At block 1010, each selected object in each object chain of the storage object that has been processed for format conversion and the temporary snapshot object are removed from the storage object.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, as described herein.

Furthermore, embodiments of at least portions of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disc, and an optical disc. Current examples of optical discs include a compact disc with read only memory (CD-ROM), a compact disc with read/write (CD-R/W), a digital video disc (DVD), and a Blu-ray disc.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A computer-implemented method for converting a storage object in a redo-log snapshot format to a single-container snapshot format in a distributed storage system, the method comprising:
taking a snapshot of the storage object to create a temporary snapshot object;
creating an anchor object that originally points to a root object of the storage object;
for each object chain of the storage object, processing each selected object in the object chain for format conversion including the temporary snapshot object, wherein processing each selected object includes:
writing difference data between the selected object and a parent object of the selected object to the anchor object;
after the difference data has been written to the anchor object, creating a child snapshot of the anchor object in the single-container snapshot format; and
updating the anchor object to point to the selected object;
after processing each selected object in each object chain of the storage object, copying data of a running point object of the storage object to the anchor object; and
removing each selected object in each object chain of the storage object that has been processed for format conversion and the temporary snapshot object from the storage object.

2. The computer-implemented method of claim 1, further comprising locking a virtual computing instance associated with the storage object prior to taking the snapshot of the storage object and unlocking the virtual computing instance after taking the snapshot of the storage object.

3. The computer-implemented method of claim 1, wherein creating the anchor object includes creating a child storage object in the single-container snapshot format of the root object.

4. The computer-implemented method of claim 1, wherein the selected objects of the storage object exclude the root object and the running point object.

5. The computer-implemented method of claim 1, further comprising, after removing the selected objects, performing a disk consolidation operation on the storage object.

6. The computer-implemented method of claim 1, wherein processing each selected object includes, before writing the data between the selected object and the parent object of the selected object to the anchor object:
comparing the object to which the anchor object points with the parent object of the selected object to determine whether the object and the parent object are the same object; and
reverting the anchor object to the parent object of the selected object when the object and the parent object are not the same object.

7. The computer-implemented method of claim 1, further comprising, after processing each selected object in each object chain of the storage object, processing any new snapshot created that has not been processed in the same manner as each of the selected objects.

8. The computer-implemented method of claim 1, further comprising, after processing each selected object in each object chain of the storage object:
determining whether the running point object exceeds a threshold size;
when the running point object exceeds the threshold size, creating another temporary snapshot of the storage object; and
processing the another temporary snapshot in the same manner as each of the selected objects.

9. The computer-implemented method of claim 1, wherein the storage object is a virtual disk for a virtual computing instance and wherein the selected objects of the storage object are selected delta disks.

10. A non-transitory computer-readable storage medium containing program instructions for converting a storage object in a redo-log snapshot format to a single-container snapshot format in a distributed storage system, wherein execution of the program instructions by one or more processors of a computer system causes the one or more processors to perform steps comprising:
taking a snapshot of the storage object to create a temporary snapshot object;
creating an anchor object that originally points to a root object of the storage object;
for each object chain of the storage object, processing each selected object in the object chain for format conversion including the temporary snapshot object, wherein processing each selected object includes:
writing difference data between the selected object and a parent object of the selected object to the anchor object;
after the difference data has been written to the anchor object, creating a child snapshot of the anchor object in the single-container snapshot format; and
updating the anchor object to point to the selected object;
after processing each selected object in each object chain of the storage object, copying data of a running point object of the storage object to the anchor object; and
removing each selected object in each object chain of the storage object that has been processed for format conversion and the temporary snapshot object from the storage object.

11. The computer-readable storage medium of claim 10, wherein steps further comprise locking a virtual computing instance associated with the storage object prior to taking the snapshot of the storage object and unlocking the virtual computing instance after taking the snapshot of the storage object.

12. The computer-readable storage medium of claim 10, wherein creating the anchor object includes creating a child storage object in the single-container snapshot format of the root object.

13. The computer-readable storage medium of claim 10, wherein the selected objects of the storage object exclude the root object and the running point object.

14. The computer-readable storage medium of claim 10, wherein the steps further comprise, after removing the selected objects, performing a disk consolidation operation on the storage object.

15. The computer-readable storage medium of claim 10, wherein processing each selected object includes, before writing the data between the selected object and the parent object of the selected object to the anchor object:
comparing the object to which the anchor object points with the parent object of the selected object to determine whether the object and the parent object are the same object; and
reverting the anchor object to the parent object of the selected object when the object and the parent object are not the same object.

16. The computer-readable storage medium of claim 10, wherein steps further comprise, after processing each selected object in each object chain of the storage object, processing any new snapshot created that has not been processed in the same manner as each of the selected objects.

17. The computer-readable storage medium of claim 10, further comprise, after processing each selected object in each object chain of the storage object:
determining whether the running point object exceeds a threshold size;
when the running point object exceeds the threshold size, creating another temporary snapshot of the storage object; and
processing the another temporary snapshot in the same manner as each of the selected objects.

18. A computer system for converting a storage object in a redo-log snapshot format to a single-container snapshot format in a distributed storage system comprising:
memory; and
at least one processor configured to:
take a snapshot of the storage object to create a temporary snapshot object;
create an anchor object that originally points to a root object of the storage object;
for each object chain of the storage object, process each selected object in the object chain for format conversion including the temporary snapshot object, wherein the at least one processor is configured to write difference data between the selected object and a parent object of the selected object to the anchor object, create a child snapshot of the anchor object in the single-container snapshot format after the difference data has been written to the anchor object, and update the anchor object to point to the selected object to process each selected object;
after each selected object in each object chain of the storage object has been processed, copy data of a running point object of the storage object to the anchor object; and
remove each selected object in each object chain of the storage object that has been processed for format conversion and the temporary snapshot object from the storage object.

19. The computer system of claim 18, wherein the at least one processor is configured to a child storage object in the single-container snapshot format of the root object to create the anchor object.

20. The computer system of claim 18, wherein the selected objects of the storage object exclude the root object and the running point object.
